(19) United States
(12) Patent Application Publication
(10) Pub. No.: US 2025/0103027 A1
(43) Pub. Date: Mar. 27, 2025

(54) AUTOMATED INDUSTRIAL AUTOMATION COMPONENT DISCOVERY AND EDGE INTEGRATION INTO A CONTAINER ORCHESTRATION SYSTEM

(71) Applicant: Rockwell Automation Technologies, Inc., Mayfield Heights, OH (US)

(72) Inventors: Nathaniel S. Sandler, Cleveland, OH (US); David C. Mazur, Mequon, WI (US); Jonathan A. Mills, Mayfield Heights, OH (US); Michael J. Anthony, Milwaukee, WI (US); Todd A. Wiese, Hubertus, WI (US); Michael A. Spaner, Deep River, CT (US)

(21) Appl. No.: 18/474,899

(22) Filed: Sep. 26, 2023

(51) Int. Cl. G05B 19/418

(52) U.S. Cl. CPC G05B 19/41835; G05B 2219/31368

(57) ABSTRACT

In a container orchestration environment implemented in an industrial automation environment, a new industrial automation component (e.g., device or software) attaches to an industrial automation network, and a pod of the container orchestration environment detects the attachment. In response, the pod creates a new pod representing the new industrial automation component by determining a type of the new industrial automation component, identifying functionality specific to the industrial automation component based on the type, provisioning software to implement the functionality, and generating a pod with containers for the software. The pod couples interfaces in the software to interfaces of the new industrial automation component and exposes the pod in the container orchestration environment, allowing the industrial automation component to participate in the container orchestration system.

### TECHNICAL FIELD

Various embodiments of the present technology relate to industrial automation devices in container orchestration systems and particularly to automated discovery of industrial automation devices and software components for automatic edge configuration in a container orchestration system.

### BACKGROUND

The concept of edge and cloud are evolving, and the lines between cloud systems and on-premises systems are blurring. Organizations are implementing environments that include cloud-based applications as well as local applications and systems. As new technology develops, these environments that span both cloud and on-premises components are evolving to look more like a single hybrid system or environment.

Container orchestration systems are used to create centralized management of containerized resources and make scaling and implementation faster and easier. Container orchestration systems are one way to create hybrid environments that span cloud and edge systems by creating clusters of nodes in the various environments that communicate across a common control plane. However, existing container orchestration systems are not equipped to provide management to some devices. General computing systems and devices are able to host software that allows the general computing system or applications and functionality of the general computing system to be implemented as pods in a cluster of the container orchestration system. However, specialized devices including industrial automation devices (e.g., drives and controllers) are unable to directly participate in a cluster.

Industrial automation devices are not able to directly participate in clusters for various reasons including that they cannot host the necessary software to engage with the container orchestration system. Further, industrial automation systems and environments typically utilize ISA-95 or Purdue model network security systems. As security concepts (e.g., Zero Trust Architecture as described by the National Institute of Standards & Technology (NIST)) in hybrid container orchestration systems, industrial automation systems cannot interact directly in the container orchestration systems because they do not meet the requirements.

Accordingly, improvements are needed to allow industrial automation devices to participate in container orchestration systems while still adhering to security standards for industrial automation environments.

### SUMMARY

Systems, devices, and methods are provided herein for implementing industrial automation components including legacy software and industrial automation devices (e.g., controllers and drives) into a container orchestration system, allowing the industrial automation components to participate in the container orchestration system. Additionally, the following description provides details of implementing automatic detection of newly connected industrial automation components for automatic creation of pods representing the industrial automation component. Further details include examples of the types of communications and operations that can be implemented in the new pod representing the industrial automation component for exposure in the container orchestration system and security implementations for ensuring standards compliance.

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus (one or more processors), cause the apparatus to perform the actions. One general aspect includes a computer-implemented method for automatically adding a pod representing an industrial automation component to a container orchestration system. The computer-implemented method includes detecting attachment of the industrial automation component to an industrial automation network, where industrial automation network supports communication of multiple industrial automation components including industrial automation devices (e.g., drives and controllers) and industrial automation software (e.g., configuration software, control logic development software, lifecycle management software, industrial automation component monitoring software, and the like) that collectively perform an industrial automation process. The method further includes, in response to detecting the attachment of the industrial automation component, creating a pod representing the industrial automation component in the container orchestration system hosted at least in part on a computing system communicably coupled with the industrial automation network. Creating the pod includes determining the type of the industrial automation component, identifying functionality specific to the industrial automation component based on the type, provisioning software that implements the functionality, generating, in the pod, a container that includes the software, and coupling interfaces in the software to interfaces of the industrial automation component. The method also includes in response to creating the pod, exposing the pod in the container orchestration system. Other embodiments of this aspect include corresponding computer systems, apparatus, and computer programs recorded on one or more computer storage devices, each configured to perform the actions of the methods.

Implementations may include one or more of the following features. Optionally, the industrial automation component is an industrial automation hardware device. In some embodiments, the industrial automation hardware device communicates over the industrial automation network using common industrial protocol (CIP). In some embodiments, the functionality includes modifying a physical or operational behavior of the industrial automation hardware device.

In some embodiments, the industrial automation component is an industrial automation software component.

In some embodiments, the computing system is an edge computing device coupled to the industrial automation network. In some embodiments, the edge computing device is initially deployed with a thin layer of compute that includes minimum software components for hosting an on-premises portion of the container orchestration system.

In some embodiments, the functionality includes at least one of: configuring the industrial automation component, monitoring behavior of the industrial automation component, and data access of the industrial automation component. In some embodiments, the functionality includes enforcing security policies associated with the industrial automation component.

In some embodiments, the computing system is a cloud-based system. In some embodiments, the container orchestration system includes multiple computing systems hosting portions of the container orchestration system that share a common control plane and operate as a single virtual system. In some embodiments, the container orchestration system is KUBERNETES.

In some embodiments, a second pod of the container orchestration system detects the attachment of the industrial automation component to the industrial automation network. In some embodiments, a third pod creates the pod representing the industrial automation component. Implementations of the described techniques may include hardware, a method or process, computer software on a computer-accessible medium, or a combination thereof.

This Summary is provided to introduce a selection of concepts in a simplified form that are further described below in the Detailed Description. While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views.

FIG. 1 illustrates a hybrid system for an industrial automation environment including industrial automation components, cloud-based components, and on-premises components.

FIG. 2 illustrates connections between, and elements of, an industrial automation device, a corresponding pod, and other pods within a container orchestration system.

FIG. 3 illustrates a message flow for automatically creating a new pod representing an industrial automation component in a container orchestration system.

FIG. 4 illustrates a method for automatically creating a new pod representing an industrial automation component in a container orchestration system.

FIG. 5 illustrates the hybrid system of FIG. 1 including trust zones and other security components for implementing robust security meeting industrial automation environment standards.

FIG. 6 illustrates connections between and elements of an industrial automation device, a corresponding pod with a policy enforcement sidecar, and other pods within a container orchestration system.

FIG. 7 illustrates a message flow for communicating between a cloud-based pod and an industrial automation component in a container orchestration system.

FIG. 8 illustrates a message flow for communicating between an on-premises pod and an industrial automation component in a container orchestration system.

FIG. 9 illustrates an example computing system used in some embodiments of the present technology.

### DETAILED DESCRIPTION

Various embodiments of the present technology relate to implementing a container orchestration system in an industrial automation environment. Current container orchestration systems are not equipped to provide management of industrial automation devices to allow them to participate directly in a cluster of the container orchestration system. However, container orchestration systems are useful for centralized management of containerized resources and making scaling and implementation faster and easier. Further, hybrid systems that span cloud and on-premises components are useful in industrial automation environments, and container orchestration systems are a good option for creating such hybrid systems.

Example container orchestration systems include open-source KUBERNETES developed by GOOGLE, AMAZON WEB SERVICES (AWS) FARGATE, AZURE Container Instances (ACI), GOOGLE Cloud Run, GOOGLE Kubernetes Engine (GKE), AMAZON Elastic Kubernetes Service (EKS), AZURE Kubernetes Service (AKS), OPENSHIFT Container Platform by RED HAT, SUSE RANCHER, DOCKER developed by DOCKER, and Nomad developed by HASHICORP. Software, hardware, methods, and features described herein provide ways for extending existing container orchestration systems to allow industrial automation components to participate in the container orchestration systems, which was not previously possible. Container orchestration systems are typically portable, extensible platforms for managing containerized workloads. Some container orchestration systems are open source, such as KUBERNETES.

In an industrial automation environment including industrial automation hardware devices (e.g., process machines, controllers, drives, and the like) and industrial automation software (e.g., industrial automation device configuration software, control logic development software, lifecycle management software, industrial automation component monitoring software, and the like), an on-premises portion of a container orchestration system is implemented and hosted on an edge device. The on-premises portion communicates with a cloud-based portion using a common control plane of the container orchestration system. The on-premises portion may be deployed having a thin layer of compute in some embodiments. For example, the system hosting the on-premises portion may be an edge server, a portion of a blade server, or any other computing system that includes a processor and memory for implementing the described functionality. To achieve the thin layer of compute deployment, the on-premises portion is deployed with minimum software components for hosting the on-premises portion of the container orchestration system and automatically configuring pods representing the industrial automation components in the on-premises cluster.

After deployment, the container orchestration may deploy a pod to discover industrial automation components attached to networks accessible to the container orchestration system. Alternatively or additionally, as industrial automation devices are attached to the industrial automation network, a pod may detect the new industrial automation components and automatically create a pod representing the industrial automation component. The pods representing the industrial automation components can be created specifically for the industrial automation component the pod represents. For example, the pod creating the new pods may detect the type of component and provision software to implement functionality that is relevant to the type of component that is being added. Accordingly, as new pods are generated, the compute used at the edge device grows to accommodate the pods that are automatically deployed representing the industrial automation components.

As the automatically deployed pods are created and exposed, other pods within the cloud-based portion and the on-premises portion of the container orchestration system can see and interact with the automatically deployed pods. Security concerns with exposing industrial automation components may be addressed using sidecar security components on the pods or using security enforcement software within the pods as described in more detail herein.

The described methods and systems advantageously provide details for implementing a container orchestration system in an industrial automation environment. The description provides a way to represent the industrial automation devices in the container orchestration system, which was previously not possible. Additionally, security configurations are discussed for addressing standards and requirements for interacting with industrial automation components in an industrial automation environment. Further, automatic deployment of the pods representing the industrial automation components provides multiple benefits. Because the pod creation is automatic, the time needed to implement the industrial automation component in the container orchestration system is reduced and the risk of error in configuration is limited. Also, in prior systems that implement edge communication with industrial automation devices, the edge devices have to be provisioned with all the necessary software and security implementations. The provisioning is time consuming, prone to error, and the compute needed for the edge devices is high to account for the extensive software requirements. Auto creation allows for deployment of an edge device with a thin layer of compute that can easily expand as needed by addition of other edge devices or expansion of compute resources in the edge device as needed in the container orchestration system. Further, the software can be provisioned from the cloud-portion of the container orchestration system, keeping the on-premises portion of the container orchestration system light until a need for the software arises.

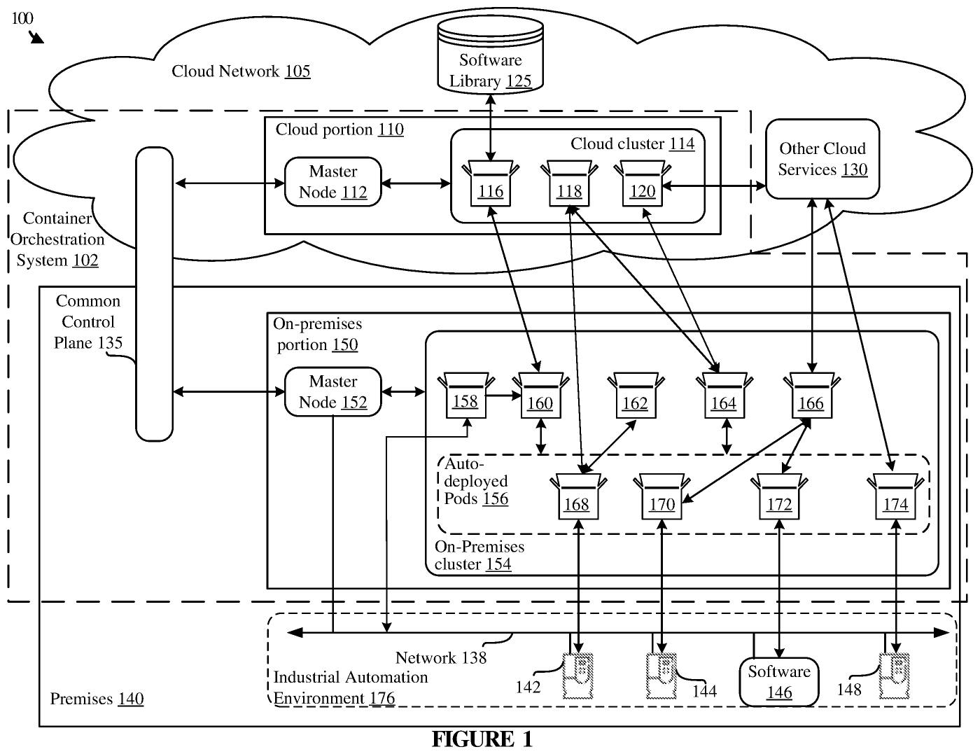

Turning now to the Figures, FIG. 1 illustrates a hybrid system 100 that includes cloud-based and on-premises based components implementing a container orchestration system 102 that interfaces with an industrial automation environment 176. The hybrid system 100 includes a cloud network 105 and a premises 140, each including components of the container orchestration system 102. Cloud network 105 may include cloud-based services and components. The premises 140 represents a local, on-premises portion of an organization that includes an industrial automation environment 176.

Container orchestration system 102 is any suitable system that manages containerized applications. Container orchestration system 102 can, for example, automate deployment, scaling, and management of containerized applications. As described in more detail below, container orchestration system 102 can be a hybrid system that spans cloud-based portions and on-premises portions so that the entire system appears as a single, virtual system.

Within the container orchestration system 102, various components (e.g., pods) can communicate with each other to exchange data across cloud-based components and on-premises components.

Cloud network 105 may be implemented using the Internet as is known in the art. In some embodiments, cloud network 105 is implemented using security that limits access to cloud portion 110, software library 125, and other cloud services 130 to authorized users. Cloud network 105 includes cloud portion 110 of the container orchestration system 102, software library 125, and other cloud services 130.

Software library 125 may be implemented in any cloud-based storage. Software library 125 includes software that can be used in pods to implement specific functionality within the pod. The software may include software for accessing data of an industrial automation component, configuring an industrial automation component, monitoring an industrial automation component, and the like.

Other cloud services 130 may include any other services hosted in a cloud-based implementation. Other cloud services 130 may include services hosted or implemented by third parties. For example, other cloud services 130 may include storage services (e.g., databases, data warehouses, datalakes, and the like), analysis services, machine learning or artificial intelligence services, maintenance services (e.g., Computerized Maintenance Management Systems (CMMS)), Enterprise Resource Planning (ERP) systems, backup and restore services, firmware management services, energy services, operational services, design services, analytics services, or the like. Other cloud services 130 may be any services used in the organizations larger IT infrastructure so that data exchanged with auto-deployed pods 156 may be used and reused to bring additional value. As such, any suitable cloud service may be given access as one of the other cloud services 130 for engaging with pods in the container orchestration system 102.

Cloud portion 110 of the container orchestration system 102 may be the portion of the container orchestration system 102 hosted in a cloud-based environment. Cloud portion 110 includes master node 112 and cloud cluster 114. In some embodiments, multiple master nodes and multiple clusters may be included in cloud portion 110. For example, master node 112 may interface with additional clusters than cloud cluster 114. In some examples, a different master node interfaces with each cloud cluster. For ease of description, a single master node 112 and a single cloud cluster 114 are described.

Master node 112 interfaces with cloud cluster 114 and common control plane 135 to ensure the state of cloud cluster 114 meets the desired configuration within container orchestration system 102. For example, master node 112 ensures that pods are deployed within cloud cluster 114 to meet the desired configuration. Master node 112 is also responsible for re-deploying pods when nodes that are hosting pods are powered off, for example. Common control plane 135 interfaces with master node 112 and master node 152 to ensure cloud portion 110 and on-premises portion 150 of the container orchestration system 102 appear collectively as a single virtual system.

Cloud cluster 114 includes pods hosted on cloud portion 110 of the container orchestration system 102. Three pods including pod 116, pod 118, and pod 120 are shown for case of description and to show various configurations. However, more or fewer than three pods may be hosted in cloud cluster 114. Each pod is deployed on a node (e.g., physical device such as a server computing system, blade server, or other type of hosting device). Each of the pods including pod 116, pod 118, and pod 120 include at least one container and each container includes software for implementing a containerized application or functionality. For example, pod 116 includes a container that includes software for accessing software library 125 to obtain software. Pod 116 further includes functionality that allows pod 116 to interface (i.e., communicate) with pod 160. The functionality that allows pod 116 to interface with pod 160 may be in the same software or container as the software that provides the functionality for accessing software library 125 or it may be in a different container or software in pod 116. Pod 118 includes software with functionality for accessing pod 164 and pod 168. Pod 120 includes software with functionality for accessing pod 164 and other cloud services 130. Pods within cloud cluster 114 may also communicate with each other (e.g., pod 118 can be configured to communicate with pod 120). Pods may communicate with each other directly via API calls. In some embodiments, pods may communicate with each other or with other components (e.g., software library 125, other cloud services 130, industrial automation components 142, 144, 146, 148) via a message bus.

Premises 140 includes one or more physical locations for an organization that includes an industrial automation environment 176. Premises 140 can include multiple physical locations each implementing a portion of the industrial automation environment 176 and an on-premises portion 150 of the container orchestration system 102. For ease of description, a single premises 140 is shown and described. Premises 140 includes on-premises portion 150 of the container orchestration system 102 and industrial automation environment 176.

Industrial automation environment 176 includes industrial automation network 138 and industrial automation components including industrial automation device 142, industrial automation device 144, industrial automation software 146, and industrial automation device 148. Industrial automation software 146 includes software that provides functionality related to the industrial automation environment 176. Industrial automation software 146 may be installed on one or more computing systems in the industrial automation environment 176. Only one industrial automation software 146 is shown for ease of description, but industrial automation environment 176 can include many different types of software and many different instances of each type of software. For example, industrial automation software 146 may include software for configuring, monitoring, or controlling industrial automation devices 142, 144, or 148. More specifically, as one example, industrial automation software 146 may include development software for creating control logic loaded onto a controller for executing a portion of an industrial automation process using an industrial automation machine. Industrial automation device 142 may be, for example, a controller coupled to an industrial automation machine, and the control logic generated by industrial automation software 146 can be installed on industrial automation device 142 for instructing the industrial automation machine to perform the process. As another example, industrial automation software 146 may include software for monitoring the health of industrial automation device 144 based on outputs, sensor data, or contextualized information provided by industrial automation device 144. When industrial automation software 146 determines industrial automation device 144 is unhealthy, industrial automation software 146 may generate a notification to alert a user of the condition of industrial automation device 144. As yet another example, industrial automation software 146 may include software for setting configuration information for industrial automation device 148.

Industrial automation device 142, industrial automation device 144, and industrial automation device 148 may be any physical devices configured to communicate on industrial automation network 138 in industrial automation environment 176. Example devices include drives, controllers, overloads, servo controllers, starters, sensors, and the like. While three industrial automation devices are shown for ease of description and to show various configurations, any number of industrial automation devices may be present in industrial automation environment 176. Examples of industrial automation devices include drives and controllers (e.g., programmable logic controllers) coupled to an industrial automation machine that physically performs portions of the industrial automation process. Examples of the industrial automation process include processes for oil refinery, processes for making physical products such as automobiles, processes for bottling or canning, and the like. Industrial automation machines include machinery such as conveyors, robotic machines, and the like. Industrial automation device 142 can be, for example, a drive that drives a motor for moving the conveyor. Industrial automation device 144 can be, for example, a controller that interfaces with the robotic machine and instructs the robotic machine to move to in specific ways to perform the industrial automation process. Industrial automation device 148 may also be a drive or controller or some other hardware component used in industrial automation environment 176.

Industrial automation network 138 may include portions of the network that utilize an industrial communication protocol such as, for example, Common Industrial Protocol (CIP). Industrial communication protocols are protocols used in industrial automation environments that adhere to standards for use with industrial automation components for safety, security, and the like. Industrial automation network 138 may include portions of the network that utilize a standard protocol such as Internet Protocol (IP) or any other standard protocol for typical communication between generic computing devices and with other devices on the Internet. Some components on industrial automation network may have more than one interface such that they may communicate on both portions of the network.

On-premises portion 150 of the container orchestration system 102 includes the portion hosted on a device on premises 140. The device may include an edge server, a portion of a server, a portion of a blade server, or the like. In some embodiments, there are multiple devices hosting various on-premises portions of the container orchestration system 102, but a single on-premises portion 150 is shown here for ease of description. On-premises portion 150 includes master node 152, and on-premises cluster 154. In some embodiments, multiple master nodes and multiple clusters may be included in on-premises portion 150. For example, master node 152 may interface with additional clusters than on-premises cluster 154. In some examples, a different master node interfaces with each cluster. For ease of description, a single master node 152 and a single on-premises cluster 154 are described.

Master node 152 interfaces with on-premises cluster 154 and common control plane 135 to ensure the state of on-premises cluster 154 meets the desired configuration within container orchestration system 102. For example, master node 152 ensures that pods are deployed within on-premises cluster 154 to meet the desired configuration and re-deploys pods when needed. For example, if a pod is deployed on a separate device (e.g., a different edge server) from master node 152, and the separate device or node is powered off, master node 152 re-deploys the pod. Master node 152 can further communicate on industrial automation network 138 in some embodiments. Since master node 152 can communicate on industrial automation network 138, master node 152 can detect when new industrial automation components attach to industrial automation network 138. Master node 152 may be able to communicate with industrial automation network 138 via a message bus.

On-premises cluster 154 includes pods hosted on the on-premises portion 150 of the container orchestration system 102. Nine pods including pod 158, pod 160, pod 162, pod 164, pod 166, pod 168, pod 170, pod 172, and pod 174 are shown for case of description and to show various configurations. However, more or fewer than nine pods may be hosted in on-premises cluster 154. Each of the pods including pod 158, pod 160, pod 162, pod 164, pod 166, pod 168, pod 170, pod 172, and pod 174 include at least one container and each container includes software for implementing a containerized application or functionality. For example, pod 164 includes a container that includes software for implementing functionality for communicating with auto-deployed pods 156, pod 118 of cloud cluster 114, and pod 120 of cloud cluster 114. Pods can communicate with each other, including pods that are in different clusters, via direct API calls, in some embodiments. In some embodiments, pods may communicate with each other or with other components such as cloud services 130 and devices on industrial automation network 138 via a message bus.

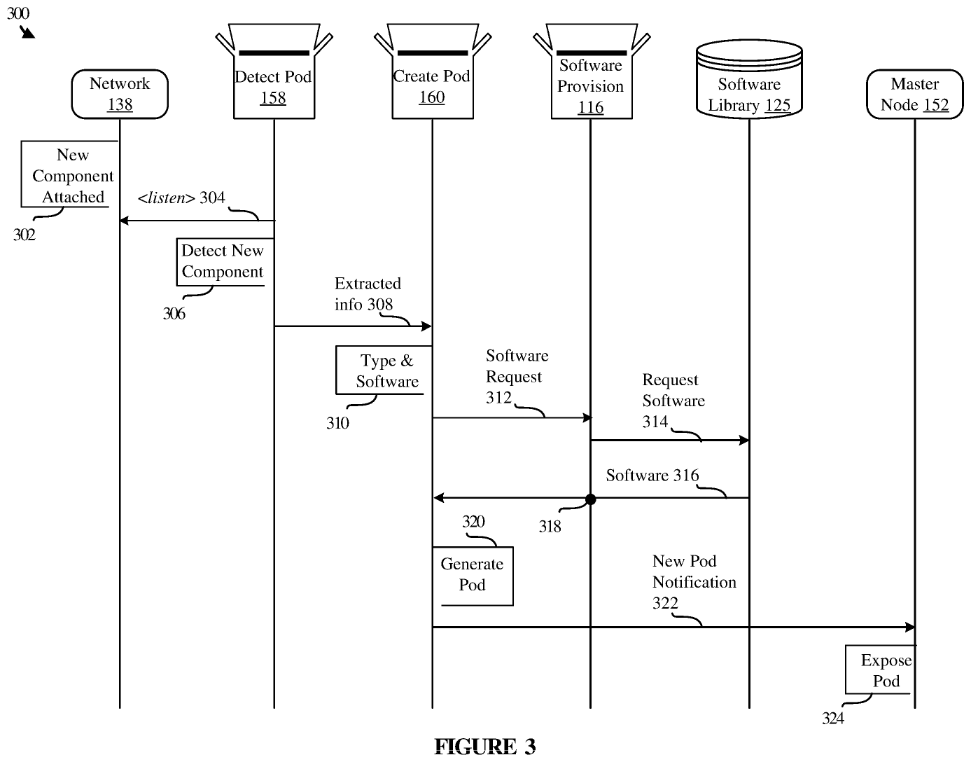

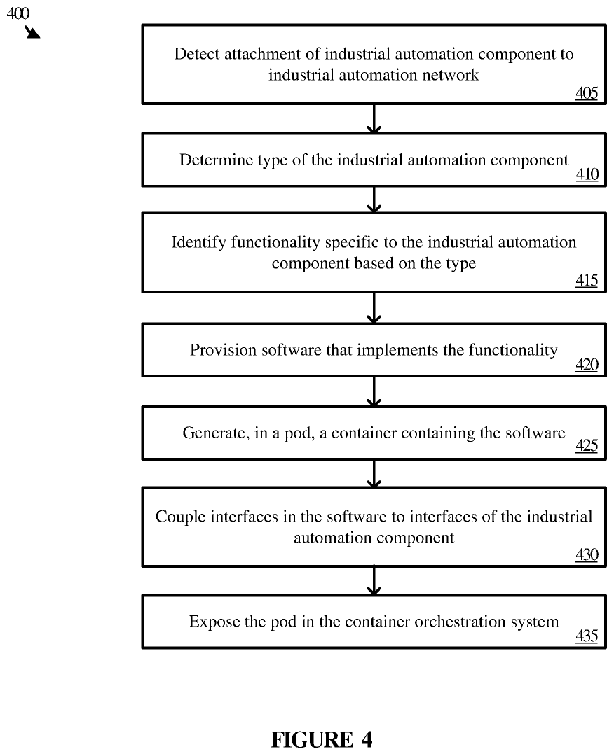

Auto-deployed pods 156 are pods that are automatically created by pod 160 when a new industrial automation component such as industrial automation software 146 or industrial automation device 142 is attached to industrial automation network 138, the process of which is described in more detail below and with respect to FIGS. 3 and 4. Auto-deployed pods 156 include pod 168, pod 170, pod 172, and pod 174. Each of the auto-deployed pods 156 include at least one container that has software for implementing functionality representative of an associated industrial automation component (e.g., industrial automation devices 142, 144, 148 or industrial automation software 146). For example, pod 168 represents industrial automation device 142, pod 170 represents industrial automation device 144, pod 172 represents industrial automation software 146, and pod 174 represents industrial automation device 148. Auto-deployed pods 156 may be able to interface with other pods in the on-premises cluster 154, other pods in cloud cluster 114, other cloud services 130, or a combination. For example, pod 168 can communicate with pod 160, pod 162, and pod 164 in on-premises cluster 154. Note that pod 160 and pod 164 can communicate with all auto-deployed pods 156. Pod 168 can also communicate with pod 118 in cloud cluster 114. Further, pod 174 can communicate with other cloud services 130. The various configurations shown by the arrows indicate that communication happens between the various pods. In some embodiments, auto-deployed pods 156 may communicate with each other (e.g., pod 172 can communicate with pod 170). In some embodiments, rather than using the pods for communication, industrial automation software 146 simply communicates with industrial automation device 144 via industrial automation network 138 directly. Auto-deployed pods 156 may act as a data access server for the associated industrial automation component within container orchestration system 102. In some embodiments, auto-deployed pods 156 may directly pass messages including CIP requests or translate messages between a different protocol (e.g., Open Platform Communications Unified Architecture (OPC UA), Message Queuing Telemetry Transport (MQTT), and the like) and CIP to make data from the associated industrial automation component available via other protocols between industrial automation environment 176 and container orchestration system 102.

Pod 158 is a detection pod that is deployed by master node 152 to detect when an industrial automation component (e.g., industrial automation devices 142, 144, and 148 or industrial automation software 146) attaches to industrial automation network 138. Pod 158 can communicate with industrial automation network 138 via, for example, a message bus. In some embodiments, pod 158 is connected to industrial automation network 138 and receives notification when a new component is detected. For example, a broadcast message may be sent on industrial automation network 138 when a new component is attached, and pod 158 may listen for such messages. In some embodiments, detection pod 158 or another pod can be deployed to discover industrial automation components (e.g., industrial automation device 142, industrial automation device 144, industrial automation software 146, and industrial automation device 148) that were previously attached to industrial automation network 138. For example, an EtherNet/Internet Protocol (IP) broadcast message (i.e., List Identity) to industrial automation components on industrial automation network 138. The industrial automation components can respond with device identity information (e.g., from a device internal identity data object). Data in the response or obtained when a new component attaches to industrial automation network 138 may include a vendor identifier (manufacturer), device type, product code identifying the particular device within the device type category, firmware revision, status, network serial number, product name, and the like. The device type may include a profile of the device category such as AC drive, motor starter, contactor, motor overload, proximity switch, and the like. In some embodiments, when a new device attaches, an IP address of the newly attached component is obtained, and an explicit request can be sent to the IP address for the component information described above. Regardless of whether the component attached to the industrial automation network 138 was detected as previously attached or as a newly attached component, the pod that detected the component (e.g., pod 158) determines whether the detected industrial automation component should be exposed in container orchestration system 102 based on, for example, the type of the industrial automation component. Upon determining that the industrial automation component should be exposed in the container orchestration system 102, pod 158 notifies pod 160 to automatically create and deploy a new pod representing the industrial automation component (i.e., a new auto-deployed pod 156). In some embodiments, pod 158 can be an extension of project Akri to be a discovery agent. Project Akri is hosted by the Cloud Native Computing Foundation (CNCF) as a sandbox project.

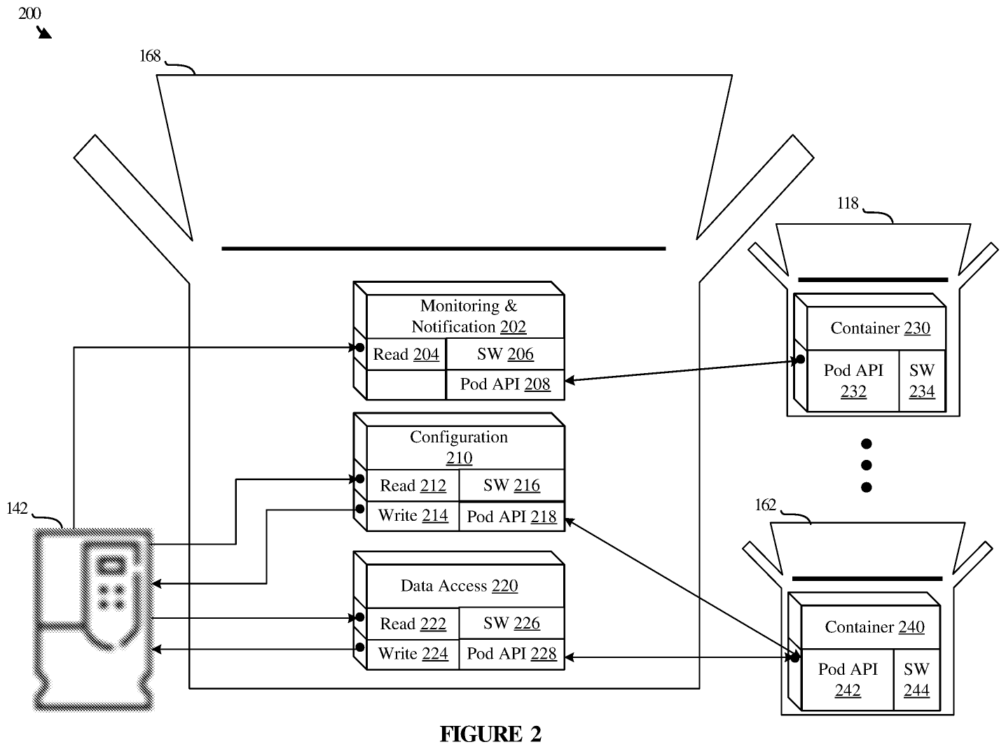

Pod 160 receives the information from pod 158 and determines the type of the industrial automation component. Based on the type of the industrial automation component, pod 158 identifies functionality and associated software specific to that type of industrial automation component that should be exposed to allow other pods to interface through the new auto-deployed pod with the industrial automation component. In other words, pod 160 selects the software specific to the type of industrial automation component. In some cases, the software is identified using rules or other static implementation. In other cases, machine learning algorithms can be used to select the software relevant to the industrial automation component as part of the software of pod 160. Once the software is identified and selected, pod 160 provisions the software that implements the functionality. As shown in FIG. 1, pod 160 requests the software from pod 116. Pod 116 queries software library 125 for the software. Pod 116 returns the software to pod 160 for implementing in the new auto-deployed pod. Pod 160 generates the pod and creates any necessary containers in the pod to place the software for containerized execution. For example, when industrial automation device 142 is attached, pod 160 creates and deploys pod 168 to represent industrial automation device 142 in the container orchestration system 102. The software may include software to configure, manage, monitor, or control industrial automation device 142 as is discussed in more detail with respect to FIG. 2. In some embodiments, pod 160 can be an extension of project Akri developed by MICROSOFT to be a pod creation agent.

FIG. 2 illustrates a portion 200 of hybrid system 100 of FIG. 1 that shows connections between, and additional details of, industrial automation device 142, corresponding pod 168, and other pods 118 and 162 within the container orchestration system 102.

Industrial automation device 142 is used for this example, but the description here is equally applicable to industrial automation software 146 or industrial automation devices 144 and 148. Pod 168 is an auto-deployed pod that represents industrial automation device 142 as described with respect to FIG. 1. As previously discussed, each pod includes one or more containers implementing software that provides functionality in container orchestration system 102. For ease of description, a single pod is used in the figures to represent each industrial automation component, however, in some embodiments more than one pod may be used to represent a single industrial automation component. For example, different functionality may be exposed by each pod for interfacing with a single industrial automation component. Further, in some embodiments, a single pod may be used to interface with more than one industrial automation component. For example, a single pod including functionality for monitoring and notification can be used to interface with multiple industrial automation components.

When pod 160 provisions the software for pod 168 to represent industrial automation device 142, the determination, in this example, is to include software for monitoring and notification, configuration, and data access, based on what is shown in FIG. 2. Accordingly, pod 168 includes monitoring and notification container 202, configuration container 210, and data access container 220. While these three containers are shown in this example, different, more, or fewer containers may be included in pod 168. Additionally, more than one pod representing industrial automation device 142 may be created. For example, three separate pods could be created, each containing one container. In other words, more than one pod can be used to represent industrial automation device 142, and each pod can include different functionality for interfacing with industrial automation device 142 in the container orchestration system 102.

Monitoring and notification container 202 includes software 206 that exposes functionality in the container orchestration system 102 for reading data from industrial automation device 142 and communicating notifications based on the data. Accordingly, read interface 204 of monitoring and notification container 202 is configured to obtain data from one or more outputs of industrial automation device 142. For example, sensor data or other data indicating whether industrial automation device 142, any corresponding industrial automation machines, or a combination are properly operating or experiencing faults may be included in information from industrial automation device 142 that is monitored. When pod 160 creates pod 168, it couples the output interfaces of industrial automation device 142 to read interface 204 by configuring read interface 204 to access the output interfaces of industrial automation device 142. Read interface 204 may communicate with industrial automation device 142 via a message bus or directly with API calls in various embodiments. Additionally, monitoring and notification container 202 includes a pod application programming interface (API) 208 to interface with APIs of software in containers in other pods in the container orchestration system 102. For example, pod 162, which is a pod in cloud cluster 114, includes container 230 which implements software 234 that includes functionality that can be used to perform actions relevant to monitoring and notification regarding data from industrial automation devices. Software 234 may include device adapter software, file extraction software, data extraction software, and the like. One example of software 234 includes FACTORYTALK by ROCKWELL AUTOMATION. Monitoring may include monitoring device state, reporting on faults and alarms, reporting on firmware revision, visualizing or alerting on runtime values, reporting on maintenance information, and the like. As one example, firmware versions can be exposed that can be used for system-wide visibility into device lifecycle management. Software 234 may include notification rules and configurations for obtaining the monitoring data from monitoring and notification container 202 and sending notifications to other components, servers, pods, or the like within the container orchestration system 102. Container 230 includes pod API 232 which interfaces with pod API 208 of monitoring and notification container 202 to exchange data between the software in each container. Communication may be via a message bus or directly with API calls in various embodiments. In some embodiments, monitoring and notification container 202 is combined with data access container 220 and software in pods 118 and 162 can implement the monitoring or control functionality as needed.

Pod 168 further includes configuration container 210. Configuration container 210 includes a read interface 212, write interface 214, software 216, and pod API 218. Configuration container 210 may include software 216 that exposes functionality in the container orchestration system 102 for configuring data within industrial automation device 142. Therefore, read interface 212 is configured to obtain data from certain outputs of industrial automation device 142. For example, when pod 160 creates pod 168, it couples output interfaces of industrial automation device 142 to read interface 212 by configuring read interface 212 to access the output interfaces of industrial automation device 142. Communication may be via a message bus or directly with API calls in various embodiments. Write interface 214 is configured to write data to certain inputs of industrial automation device 142 by similarly coupling write interface 214 to the inputs of industrial automation device 142. Pod API 218 can communicate with APIs in other pods and in this example is configured to communicate with pod API 242 of container 240 in pod 162. Communication may be via a message bus or directly with API calls in various embodiments. Pod 162 is a pod in on-premises cluster 154. Software 244 of container 240 may include software for programming configuration settings of an industrial automation device. It may transmit, via pod API 242 to pod API 218, configuration data for implementing in industrial automation device 142. Software 216 may, for example, determine whether the configuration is allowed, translate the configuration data into a common industrial protocol (CIP) message, or the like, and transmit the configuration data to industrial automation device 142 via write interface 214.

Pod 168 additionally includes data access container 220. Data access container 220 includes read interface 222, write interface 224, software 226, and pod API 228. Data access container 220 includes software 226 that exposes functionality in container orchestration system 102 to read and write data to industrial automation device 142 for controlling behavior of industrial automation device 142 and any corresponding industrial automation machines controlled by industrial automation device 142. For example, software 226 may be used to provide new or modified control logic to industrial automation device 142, control whether the corresponding industrial automation machine is running or not running (e.g., whether it is actively executing actions in the industrial automation process), access specific inputs and outputs including sensor data of industrial automation device 142, and the like. In some embodiments, firmware versions are exposed for the industrial automation device 142, and lifecycle management functionality can be used to configure and trigger firmware updates to industrial automation device 142 based on the exposed information. Read interface 222 is configured to obtain data from relevant outputs of industrial automation device 142, and write interface 224 is configured to write data to relevant inputs of industrial automation device 142. When pod 160 creates pod 168, it configures read interface 222 and write interface 224 accordingly. Pod API 228 is configured to communicate with APIs in other pods and in this example is configured to exchange data with pod API 242 of container 240 in pod 162. Communication may be via a message bus or directly with API calls in various embodiments. Software 244 may also include functionality for modifying the state of the industrial automation device 142 (e.g., turning it on or off), modifying control logic in industrial automation device 142, or the like. The data from software 244 may be transmitted, via pod API 242 to pod API 228, to data access container 220. Software 226 may determine whether the activity is allowed, generate a CIP message to instruct industrial automation device 142 to implement the activity, and the like. The message can be sent to industrial automation device 142 inputs via write interface 224. Responsive information can be obtained from industrial automation device 142 via read interface 222. In some embodiments, additional software and pods may be created for deploying artificial intelligence software and systems based on the specific industrial automation component that is added to industrial automation network 138.

FIG. 3 illustrates a message flow 300 for automatically creating and deploying a new pod representing an industrial automation component (e.g., industrial automation device 144) in container orchestration system 102. Detect pod 158 is configured to detect new industrial automation components added to industrial automation network 138. For example, detect pod 158 may periodically check for new components added to industrial automation network 138. In some embodiments, detect pod 158 may listen on industrial automation network 138 for newly attached components, for example, based on a broadcast message when a new component is attached. In some embodiments, detect pod 158 walks industrial automation network 138 to identify all components attached to industrial automation network 138. For example, detect pod 158 may communicate with a component (e.g., router, DHCP server, industrial communication protocol device, or the like) that manages communication on industrial automation network 138 and knows of all attached components to get a list of attached components. Any of these methods may be used in any combination for detect pod 158 to detect a new component 302 attached to industrial automation network 138.

As shown in FIG. 2, new component is attached 302 to industrial automation network 138. Detect pod 158 is listening 304 and detects the new component at 306. Upon detecting the new component, detect pod 158 extracts or obtains relevant information about the new component at 306. Detect pod 158 can use the information to determine whether a new pod should be generated in container orchestration system 102 to represent the new component. For example, certain types of devices may be configured to be deployed as a pod while other types of devices are not. Upon determining that a new pod should be generated, detect pod 158 compiles relevant extracted information for the create pod 160 to use. For example, detect pod 158 may extract the type of the new component (e.g., a specific type of industrial automation device like controller or drive, whether the component is a software component and, if so, the type of software, and the like). Any information needed for creation of the new pod is extracted and compiled by detect pod 158. The extracted information 308 is transmitted to create pod 160. The data transmission may be via a message bus or directly with an API call in various embodiments. Create pod 160 determines the type of the new component and any functionality that should be implemented and exposed in the container orchestration system 102 based on the type. For example, a set of rules may be used to determine the functionality to expose, a machine learning model may be used to determine the functionality to expose, or some combination of the two can be used. Once the functionality is determined, create pod 160 identifies the software needed to implement the functionality at 310 and generates a request for the software. Create pod 160 sends the software request 312 to software provisioning pod 116. Create pod 160 can send the software request 312 directly with an API call or via a message bus in various embodiments. Software provisioning pod 116 generates a software request 314 (e.g., a database request) to request the software from software library 125. Software library 125 returns software 316 to software provisioning pod 116 in response to the request 314. Software provisioning pod 116 may perform some actions on software 316 or may simply route 318 the software 316 to create pod 160. Create pod 160 generates the new pod 320 by placing at least one container in the newly created pod and implementing the software 316 in the containers. Create pod 160 may send a new pod notification 322 to master node 152. Master node 152 may expose the new pod at 324 by, for example, adding the new pod to a routing table, notifying other master nodes such as master node 112 of the new pod, or the like.

FIG. 4 illustrates method 400 for automatically creating a new pod representing an industrial automation component in a container orchestration system. For example, method 400 can be used to automatically create any auto-deployed pods 156 in container orchestration system 102. Using container orchestration system 102 as the example, a new industrial automation component may be added to industrial automation network 138. For example, industrial automation software 146 may be installed on a computing device attached to industrial automation network 138. Installation of the industrial automation software 146 on the computing device can be detected by master node 152 at step 405. Master node 152 notifies detect pod 158 of the new industrial automation software 146. Detect pod 158 may determine the type of the industrial automation software 146 and whether a new pod should be created representing industrial automation software 146. When detect pod 158 determines a new pod should be created, it notifies create pod 160 to create a new pod and provides the relevant information for create pod 160 to create the pod.

At 410, detect pod 158 or create pod 160 determines the type of the industrial automation component, which in this example is industrial automation software 146. In some embodiments, both detect pod 158 and create pod 160 determine the type of the industrial automation component. For example, detect pod 158 may determine a high-level type (e.g., software vs. hardware) and create pod 160 may determine a more specific type (e.g., the exact software or hardware). In this example, detect pod 158 may determine that the type of the component is software. Detect pod 158 or create pod 160 may further determine which specific software industrial automation software 146 is. For example, industrial automation software 146 may be configuration software for configuring industrial automation devices, data access software for accessing data related to and manipulating behavior of industrial automation devices, monitoring software for monitoring lifecycle information of industrial automation devices and software, testing software for simulating industrial automation environments to test other software, design software for creating control logic for instructing controllers, or any other suitable software.

At 415, create pod 160 identifies functionality specific to the industrial automation component based on the type. For example, specific and different functionality may apply to configuration software vs. data access software vs. lifecycle monitoring software. Further, specific and different functionality may apply to software vs. hardware. Further still, specific and different functionality may apply to a drive vs. a controller. Accordingly, create pod 160 identifies the specific functionality and determines the relevant software for implementing the specific functionality. Functionality for industrial automation software 146 may include obtaining the current version, monitoring the state (running/not running) of the industrial automation software 146, updating the industrial automation software 146 to a new version, and the like.

At 420, create pod 160 provisions the software that implements the identified functionality. For example, the software may reside in software library 125, which is stored in the cloud. This may allow the device deployed to host on-premises portion 150 of container orchestration system 102 to use minimum compute resources for hosting on-premises portion 150 on initial deployment and scale as new pods are auto-deployed. Accordingly, create pod 160 may interface with software provisioning pod 116 to obtain the relevant software from software library 125.

At 425, create pod 160 generates the pod and places one or more containers containing the provisioned software. As discussed throughout, more than one pod may be generated to expose the software and functionality, more than one container in a single pod may be used, or a combination. Generating the pod and container may include installing an instance of the software in the container and configuring the included APIs to represent interfaces in a container of a specific pod, for example.

At 430, create pod 160 couples interfaces in the software to interfaces of the industrial automation component. For example, interfaces in the software in pod 172 are coupled with interfaces in industrial automation software 146. The interfaces may be coupled by creating specific configurations in the APIs of pod 172 to correspond with APIs of industrial automation software 146. This may include using address information for industrial automation software 146 on industrial automation network 138 in configuration settings of the APIs of pod 172.

At 435, the new pod is exposed in the container orchestration system. In this example, pod 172 is exposed in container orchestration system 102. The new pod can be exposed in any way suitable for the given container orchestration system. For example, create pod 160 can notify master node 152 of the new pod, and master node 152 can add pod 172 to a routing table. Once exposed, pod 172 can be used within container orchestration system 102 to expose functionality of industrial automation industrial automation software 146, and industrial automation software 146 can use pod 172 to interact with other pods and components of container orchestration system 102.

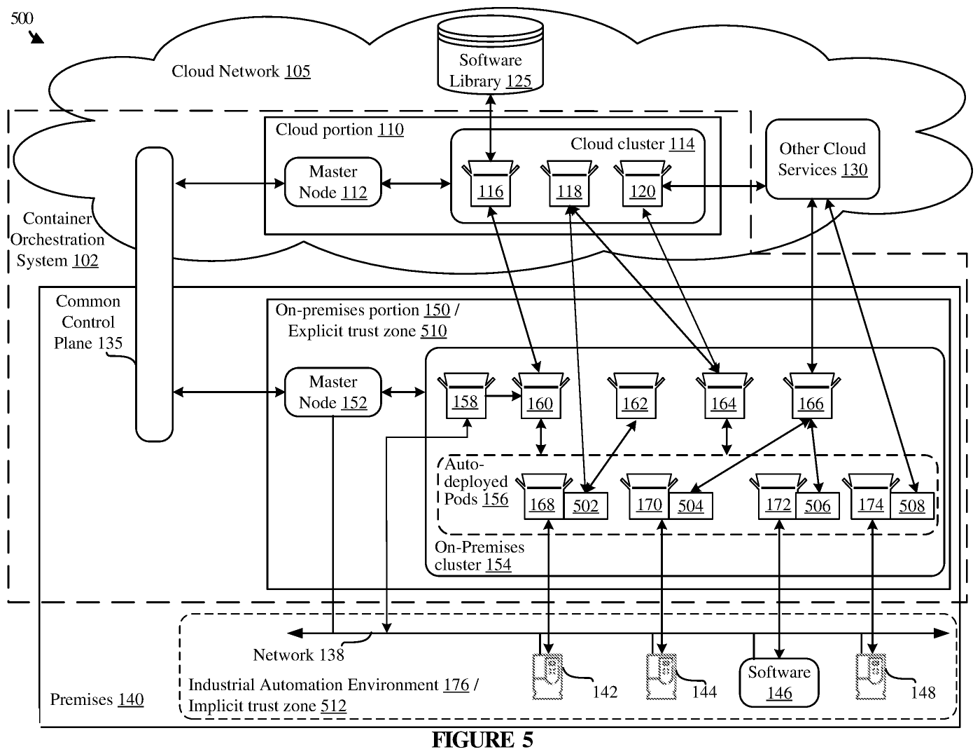

FIG. 5 illustrates the hybrid system 500, which is substantially similar to hybrid system 100 of FIG. 1 and modified for implementation of specific security features including trust zones and other security components for implementing robust security meeting industrial automation environment standards. Hybrid system 500 includes all the components described in hybrid system 100, and on-premises portion 150 of container orchestration system 102 is configured as an explicit trust zone 510 while industrial automation environment 176 is configured as an implicit trust zone 512. Further, auto-deployed pods 156 each have an associated policy enforcement point pod. Accordingly, pod 168 has associated policy enforcement point pod 502, pod 170 has associated policy enforcement point pod 504, pod 172 has associated policy enforcement point pod 506, and pod 174 has associated policy enforcement point pod 508. Policy enforcement point pods 502, 504, 506, and 508 can each be automatically deployed with the auto-deployed pods 156. The policy enforcement point pods 502, 504, 506, and 508 each include a policy enforcement point coupled with a proxy pod to represent the auto-deployed pods 156 as the interface to communicate with each auto-deployed pod 156. This, with configuration of explicit trust zone 510 and implicit trust zone 512, incorporates concepts from zero trust architectures (e.g., NIST Zero Trust Architecture) into the container orchestration system 102 and industrial automation environment 176 to ensure security requirements and standards are incorporated as required by each environment and system. A policy administrator, which can be incorporated in master node 152 or in a pod such as pod 164 or any other pod that can communicate with all auto-deployed pods 156, can work in conjunction with the policy enforcement point pods 502, 504, 506, and 508 for each auto-deployed pod 156 to control access at a per request level to industrial automation components (e.g., industrial automation devices 142, 144, 148 and industrial automation software 146) connected to industrial automation network 138. Each auto-deployed pod 156 can also implement side car containers using an ambassador pattern such that the policy enforcement point in each of the policy enforcement point pods 502, 504, 506, and 508 is the ambassador that controls access to the associated pod representing the industrial automation component.

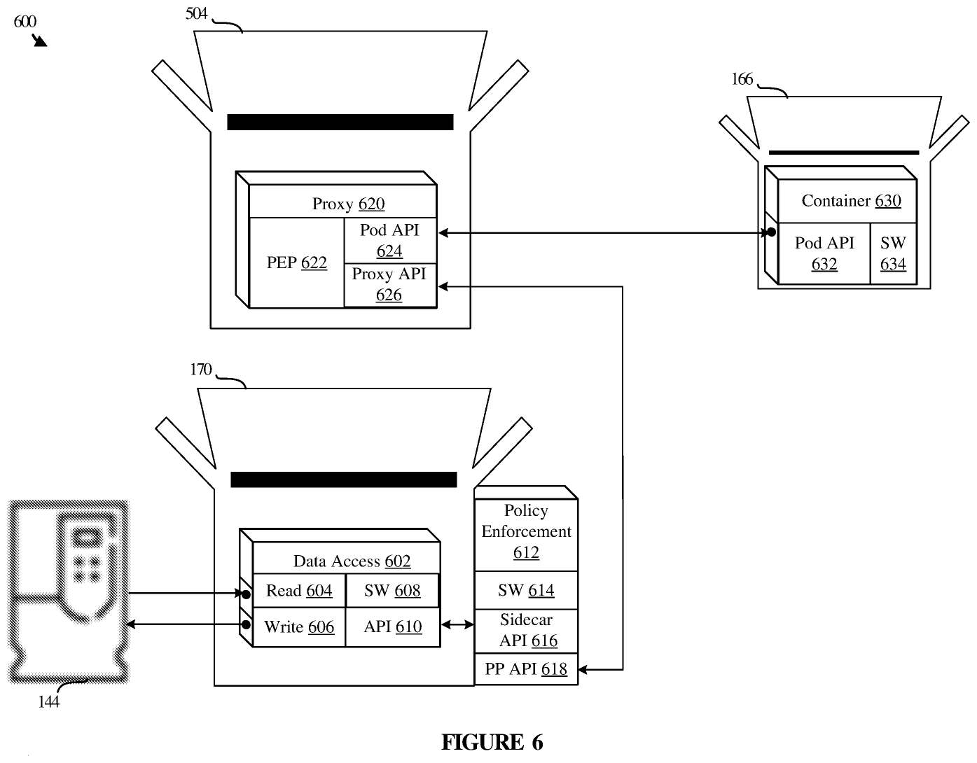

FIG. 6 illustrates portion 600 of hybrid system 500 including connections between, and elements of, industrial automation device 144, corresponding pod 170 with policy enforcement point pod 504, and pod 166 within container orchestration system 102. In this example, pod 170 representing industrial automation device 144 includes software 608 in data access container 602 for accessing and manipulating data associated with industrial automation device 144. Data access container 602, read interface 604, write interface 606, and software 608 may be substantially the same as data access container 220, read interface 222, write interface 224, and software 226 of FIG. 2, respectively. Pod 170 further includes policy enforcement sidecar 612. Policy enforcement sidecar 612 includes software 614, sidecar API 616, and proxy pod API 618. Policy enforcement sidecar 612 implements an ambassador pattern in software 614 that ensures policy enforcement point 622 is the ambassador that controls access to pod 170. When communications come in from proxy API 626 to proxy pod API 618, software 614 ensures it matches the ambassador pattern.

Pod 166 may include functionality for interfacing with industrial automation device 144 to perform data access. Pod 166 includes container 630 that implements software 634 and pod API 632. Software 634 may be substantially the same as software 244 described with respect to FIG. 2. When pod 166 wants to communicate with the pod representing industrial automation device 144, security systems have been set up to make policy enforcement point pod 504 appear to be the pod representing industrial automation device 144. Accordingly, pod 166 uses pod API 632 to communicate with pod API 624 of policy enforcement point pod 504. Policy enforcement point pod 504 includes proxy container 620 that includes the policy enforcement point 622, pod API 624, and proxy API 626. When communications come in via pod API 624, policy enforcement point 622 enforces policies to ensure the communications with industrial automation device 144 are allowed. Once the policy enforcement point 622 approves the communication, it is routed through proxy API 626 to proxy pod API 618 of policy enforcement sidecar 612. Software 614 ensures the communication matches the ambassador pattern. If so, the communication is passed via sidecar API 616 to API 610 of the data access container. Software 608 implements the communication to communicate with industrial automation device 144 via read interface 604 and write interface 606. Return communications from industrial automation device 144 follow a similar path in reverse and experience similar policy enforcement analysis to ensure the response to pod 166 is allowed. Accordingly, only allowed communications and interactions are transmitted between other pods in container orchestration system 102 and auto-deployed pods 156.

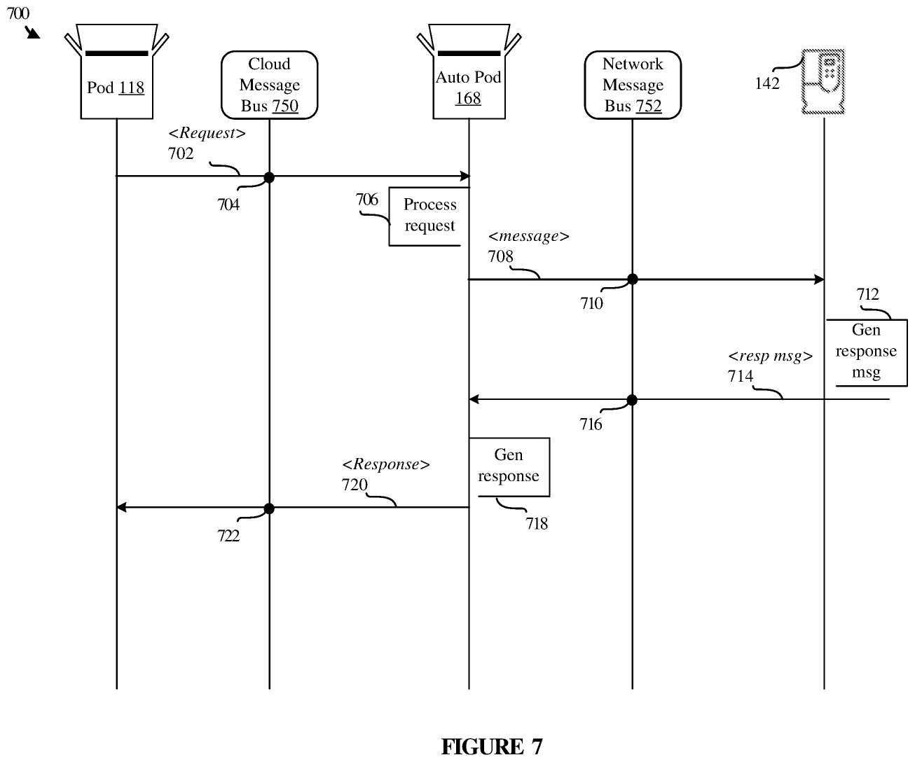

FIG. 7 illustrates a message flow 700 for communicating between a cloud-based pod and an industrial automation component in a container orchestration system and uses communication between pod 118, auto-deployed pod 168, and industrial automation device 142 in container orchestration system 102 as an example as well as communication via message busses including cloud message bus 750 and network message bus 752. Message busses are not shown in FIG. 1, but they may be used to communicate between various components of container orchestration system 102. For example, cloud message bus 750 can be a virtual message bus to communicate between pods in the cloud cluster 114 and pods in on-premises cluster 154. Message bus 752 can be a message bus to communicate between pods in on-premises cluster 154 and industrial automation components on industrial automation network 138. Pod 118 may request information from industrial automation device 142 and accordingly transmits request 702 to auto-deployed pod 168. Request 702 is routed 704 by cloud message bus 750 to auto-deployed pod 168. In response to receiving request 702, auto-deployed pod 168 may process 706 the request. For example, auto-deployed pod 168 may apply security policies, analyze the request, generate a common industrial protocol (CIP) message, or perform other operations. After completing processing, auto-deployed pod 168 generates and sends a message 708 representing the request (e.g., including a CIP instruction packaged as payload for processing by the master node 112) to industrial automation device 142. Message 708 is routed 710 via network message bus 752. Industrial automation device 142 processes message 708 and generates 712 a response message. Industrial automation device 142 sends response message 714 back to auto-deployed pod 168. Response message 714 is routed via network message bus 752 from industrial automation device 142 to auto-deployed pod 168. Auto-deployed pod generates 718 a response to the original request 702 based on response message 714. Auto-deployed pod 168 sends the response 720 to pod 118 using cloud message bus 750, which routes 722 response 720 to pod 118. Pod 118 may then use response 720 for further processing.

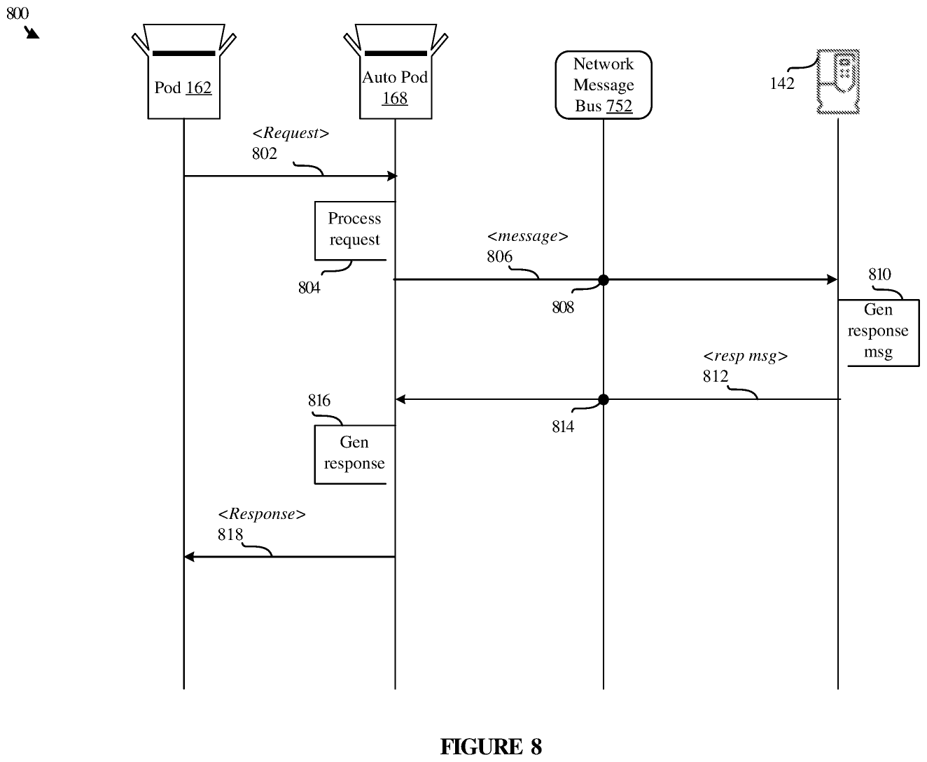

FIG. 8 illustrates a message flow 800 for communicating between an on-premises pod and an industrial automation component in a container orchestration system and uses communication between pod 162, auto-deployed pod 168, and industrial automation device 142 in container orchestration system 102 as an example. In this example, pod 162 communicates directly using API calls with auto-deployed pod 168, and auto-deployed pod 168 communicates with industrial automation device 142 using network message bus 752. Pod 162 is a pod in on-premises cluster 154. Pod 162 may request information from industrial automation device 142 and accordingly transmits request 802 to auto-deployed pod 168. In response to receiving request 802, auto-deployed pod 168 may process 804 the request. For example, auto-deployed pod 168 may apply security policies, analyze the request, generate a common industrial protocol (CIP) message, or perform other operations. After completing processing, auto-deployed pod 168 generates and sends a message 806 representing the request (e.g., including a CIP instruction packaged as payload for processing) to industrial automation device 142. Network message bus 752 routes 808 the message 806 to industrial automation device 142. Industrial automation device 142 processes message 806 and generates 810 a response message 812. Industrial automation device 142 sends response message 812 back to auto-deployed pod 168. Network message bus 752 routes 814 the response message 812 to auto-deployed pod 168. Auto-deployed pod generates 816 a response to the original request 802 based on response message 812. Auto-deployed pod 168 sends the response 818 to pod 162. Pod 162 may then use response 818 for further processing.

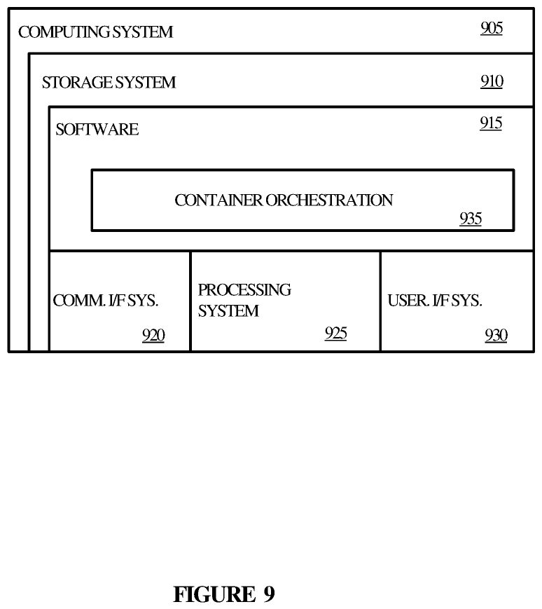

FIG. 9 illustrates computing system 905 to perform pod creation, pod communication, pod hosting, or any combination thereof, according to an implementation of the present technology. Computing system 905 is representative of any system or collection of systems with which the various operational architectures, processes, scenarios, and sequences disclosed herein for implementation of a container orchestration system in an industrial automation environment may be employed. Computing system 905 may be implemented as a single apparatus, system, or device or may be implemented in a distributed manner as multiple apparatuses, systems, or devices. Computing system 905 includes, but is not limited to, processing system 925, storage system 910, software 915, communication interface system 920, and user interface system 930 (optional). Processing system 925 is operatively coupled with storage system 910, communication interface system 920, and user interface system 930. Computing system 905 may be representative of a cloud computing device, distributed computing device, or the like.

Processing system 925 loads and executes software 915 from storage system 910. Software 915 includes and implements container orchestration 935, which is representative of any of the pod creation, pod communications, or hosting of container orchestration systems described in the preceding figures. When executed by processing system 925 to provide pod creation, pod communication, pod hosting, or any combination thereof, software 915 directs processing system 925 to operate as described herein for at least the various processes, operational scenarios, and sequences discussed in the foregoing implementations. Computing system 905 may optionally include additional devices, features, or functionality not discussed for purposes of brevity.

Processing system 925 may comprise a micro-processor and other circuitry that retrieves and executes software 915 from storage system 910. Processing system 925 may be implemented within a single processing device but may also be distributed across multiple processing devices or sub-systems that cooperate in executing program instructions. Examples of processing system 925 include general purpose central processing units, graphical processing units, application specific processors, and logic devices, as well as any other type of processing device, combinations, or variations thereof.

Storage system 910 may comprise any computer readable storage media readable by processing system 925 and capable of storing software 915. Storage system 910 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 910 may also include computer readable communication media over which at least some of software 915 may be communicated internally or externally. Storage system 910 may be implemented as a single storage device but may also be implemented across multiple storage devices or sub-systems co-located or distributed relative to each other. Storage system 910 may comprise additional elements, such as a controller capable of communicating with processing system 925 or possibly other systems.

Software 915 (including container orchestration 935) may be implemented in program instructions and among other functions may, when executed by processing system 925, direct processing system 925 to operate as described with respect to the various operational scenarios, sequences, and processes illustrated herein. For example, software 915 may include program instructions for implementing portions of the container orchestration system as described herein. For example, software 915 may include software for implementing pod creation, pod communications, or hosting portions of the container orchestration systems described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 915 may include additional processes, programs, or components, such as operating system software, virtualization software, or other application software. Software 915 may also comprise firmware or some other form of machine-readable processing instructions executable by processing system 925.

In general, software 915 may, when loaded into processing system 925 and executed, transform a suitable apparatus, system, or device (of which computing system 905 is representative) overall from a general-purpose computing system into a special-purpose computing system customized to provide pods representing industrial automation components of a container orchestration system, pod creation in a container orchestration system, pod communication in a container orchestration system, or any combination thereof as described herein. Indeed, encoding software 915 on storage system 910 may transform the physical structure of storage system 910. The specific transformation of the physical structure may depend on various factors in different implementations of this description. Examples of such factors may include, but are not limited to, the technology used to implement the storage media of storage system 910 and whether the computer-storage media are characterized as primary or secondary storage, as well as other factors.

For example, if the computer readable storage media are implemented as semiconductor-based memory, software 915 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 920 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 905 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise.” “comprising.” and the like are to be construed in an inclusive sense, as opposed to an exclusive or exhaustive sense; that is to say, in the sense of “including, but not limited to.” As used herein, the terms “connected.” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or.” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A computer-implemented method, comprising:
detecting attachment of a first industrial automation component of a plurality of industrial automation components to an industrial automation network, wherein the plurality of industrial automation components are attached to the industrial automation network and collectively perform an industrial automation process;
in response to detecting the attachment of the first industrial automation component, creating a pod representing the first industrial automation component in a container orchestration system hosted at least in part on a computing system communicably coupled with the industrial automation network, wherein creating the pod comprises:
determining a type of the first industrial automation component,
identifying functionality specific to the first industrial automation component based on the type,
provisioning software that implements the functionality,
generating, in the pod, a container comprising the software, and
coupling interfaces in the software to interfaces of the first industrial automation component;
in response to creating the pod, exposing the pod in the container orchestration system.

2. The computer-implemented method of claim 1, wherein the first industrial automation component is an industrial automation hardware device.

3. The computer-implemented method of claim 2, wherein the industrial automation hardware device communicates over the industrial automation network using Common Industrial Protocol (CIP).

4. The computer-implemented method of claim 2, wherein the functionality comprises modifying an operational or physical behavior of the industrial automation hardware device.

5. The computer-implemented method of claim 1, wherein the first industrial automation component is an industrial automation software component.

6. The computer-implemented method of claim 1, wherein the computing system is an edge computing device coupled to the industrial automation network.

7. The computer-implemented method of claim 6, wherein the edge computing device is initially deployed with a thin layer of compute comprising minimum software components for hosting an on-premises portion of the container orchestration system.

8. The computer-implemented method of claim 1, wherein the functionality comprises at least one of: configuring the industrial automation component, monitoring behavior of the industrial automation component, and data access of the industrial automation component.

9. The computer-implemented method of claim 1, wherein the functionality comprises enforcing security policies associated with the industrial automation component.

10. The computer-implemented method of claim 1, wherein the computing system is a cloud-based system.

11. The computer-implemented method of claim 1, wherein the container orchestration system comprises a plurality of computing systems hosting portions of the container orchestration system that share a common control plane to comprise a single virtual system.

12. The computer-implemented method of claim 1, wherein the detecting the attachment of the first industrial automation component is performed by a second pod of the container orchestration system.

13. The computer-implemented method of claim 1, wherein the creating the pod representing the first industrial automation component is performed by a second pod of the container orchestration system.

14. The computer-implemented method of claim 1, wherein the container orchestration system is KUBERNETES.

15. A system, comprising:
a cloud-based portion of a container orchestration system implementation, the cloud-based portion comprising:
a first pod of a plurality of pods of the container orchestration system, the first pod providing access to a library of selectable software functionality;
an on-premises portion of the container orchestration system implementation, wherein the on-premises portion is communicably coupled to the cloud-based portion via a common control plane and is communicably coupled to an industrial automation network, wherein the on-premises portion comprises:
a second pod of the plurality of pods that detects attachment of industrial automation components to the industrial automation network, wherein the industrial automation components collectively perform an industrial automation process;
a third pod of the plurality of pods that:
receives notification from the second pod that a new industrial automation component is attached to the industrial automation network;
in response to the notification, creates a new pod in the plurality of pods, the new pod representing the new industrial automation component in the container orchestration system, wherein creating the new pod comprises:
determining a type of the new industrial automation component,
identifying functionality specific to the new industrial automation component based on the type,
provisioning selected software that implements the functionality using the first pod to access the library of selectable software functionality,
generating, in the new pod, a container comprising the selected software, and
coupling interfaces in the selected software to interfaces of the new industrial automation component;
in response to creating the new pod, exposing the new pod in the container orchestration system.

16. The system of claim 15, further comprising:
an edge computing device hosting the on-premises portion of the container orchestration system implementation, wherein the edge computing device is initially deployed having a thin layer of compute comprising minimum software components for hosting the on-premises portion of the container orchestration system.

17. The system of claim 15, wherein the industrial automation components communicate over the industrial automation network using Common Industrial Protocol (CIP).

18. The system of claim 15, wherein the functionality comprises at least one of: configuring the industrial automation component, monitoring behavior of the industrial automation component, data access of the industrial automation component, enforcing security policies associated with the industrial automation component, and modifying an operational or physical behavior of the industrial automation component.

19. The system of claim 15, wherein the industrial automation components comprise industrial automation hardware devices, industrial automation software components, or a combination thereof.

20. The system of claim 15, further comprising:
the library of selectable software functionality.
